(19) United States
(12) Patent Application Publication
(10) Pub. No.: US 2008/0163493 A1
(43) Pub. Date: Jul. 10, 2008

(54) Utility Knife with Counter-Reciprocating Blade and Guard

(76) Inventor: Earl J. Votolato, Newport Beach, CA (US)

Correspondence Address: Rutan & Tucker, LLP., 611 ANTON BLVD, SUITE 1400, COSTA MESA, CA, 92626, US

(21) Appl. No.: 11/621,208

(22) Filed: Jan. 9, 2007

(51) Int. Cl. B26B 7/00

(52) U.S. Cl. 30/154

(57) ABSTRACT

A utility knife has a counter-reciprocating blade and guard. Preferred mechanism has several components, including a housing, a first pivot that pivotally couples the housing and the blade, and a second pivot that pivotally couples the housing and the guard. Preferably, of the blade and guard reciprocates such that forced retraction of the guard results in forced extension of the blade. During locked position, the guard is in a locked position and a trigger cooperates with the locking mechanism to unlock the guard. The guard can only be unlocked after releasing the trigger to a default position.

### FIELD OF THE INVENTION

The field of the invention is utility knives.

### BACKGROUND

Traditionally, utility knives have a blade either (a) extend external from a blade cover in a fixed position or (b) stored internally in a cover until the blade is manually slid out. Improvements have been made to include a variety of different mechanism to retract or extend the blade mainly for safety reasons. For examples, newer utility knives typically have a sharp cutting blade that can either be retracted into a housing, or released to an operating disposition by movement of a retractable, protective blade guard. However, the knives in these instances still require manual movement of the user to put the blade guard cover back onto the blade after use. In all these cases problems arise where the blade is left in an unprotected disposition where it can accidentally cause injury to a user.

The problem of accidental injury has been long recognized, with numerous solutions being put forward at various times. U.S. Pat. No. 4,980,977 to Matin et al. (January 1991), for example, describes a knife having a safety guard that guards the blade when not in use, and automatically retracts as the blade is removed from the workpiece. The guard has a manually triggered self-locking release assembly that automatically relocks the guard when retracted. Unfortunately, Matin's locking mechanism is external to the housing, which is dangerous because the mechanism is readily subjected to debris that could jam or otherwise interfere with both the locking and unlocking functions. In addition, Matin's safety guard pivots off the blade externally to the housing, rather than being retracted into the housing. That operation is dangerous because the pivoted guard can readily interfere with operation of the knife.

U.S. Pat. No. 5,878,501 to Owens et al. (March 1999) uses an internal locking mechanism, but leaves the blade in the “use” position for multiple uses. There are also existing designs in which a blade is fixed to a sliding mechanism and is pushed out of the knife manually by the user. The blade is spring-loaded to retract back when a cut has been completed depending on whether a user is still pushing the blade or releasing the mechanism that pushes the blade out. The problem still exists that there is no automatic re-locking mechanism, which can still cause injuries to the user.

More recently the present inventor pioneered utility knives having a mechanism that automatically re-locks the protective blade guarding to prevent more than a single use of the blade. Pending applications include Ser. No. 09/804,451, published in September 2002 as 2003/0131393, and Ser. No. 10/300,382, published in May 2004 as 2004/0093734. (also need to discuss 0020US1) These and all other referenced patents and applications are incorporated herein by reference in their entirety.

While providing considerable improvement over the prior art, the preferred embodiments of the utility knives described in the Ser. Nos. 09/804,451 and 10/300,382 applications have more “play” in the blade guard than might be desired in some circumstances. In the Ser. No. 10/300,382 application, for example, a preferred locking mechanism utilizes a pawl that rides in a looped pathway. Two ramped steps on the pathway limit the pawl's travel to a one-way direction, so that once the pawl starts along the pathway, it must finish a complete loop. The mechanism; however, allows some slight backward motion of the pawl, and thus introduces potentially undesirable play in the blade guard.

Thus, there is a need for an improved locking/releasing mechanism that automatically re-locks the protective blade guarding to prevent more than a single use of the blade, while reducing the play in the blade guard.

This and all other referenced extrinsic materials are incorporated herein by reference in their entirety. Where a definition or use of a term in an incorporated reference is inconsistent or contrary to the definition of that term provided herein, the definition of that term provided herein applies and the definition of that term in the reference does not apply.

### SUMMARY OF THE INVENTION

The present invention provides apparatus, systems and methods in which a utility knife has a counter-reciprocating blade and guard. Preferred mechanism has several components, including a housing, a first pivot that pivotally couples the housing and the blade, and a second pivot that pivotally couples the housing and the guard. Preferably, there also is a coupling mechanism that couples reciprocation of the blade and guard such that forced retraction of the guard results in forced extension of the blade.

In preferred embodiments, the blade is disposed within a blade holder, which pivots about a first pivot, and the guard is pivotally coupled to the blade holder at a second pivot positioned eccentrically to the first pivot. During a locked position, the housing and a locking mechanism locks the guard in a locked position and the locking mechanism is entirely internal to the housing.

In another aspect of the preferred embodiment, the blade extends from a edge of the housing when the guard is in the locked position and the blade is entirely disposed within the housing when the guard is in the locked position. Preferably, a trigger cooperates with the locking mechanism to unlock the guard and the trigger extends inferiorly from a lower surface of the housing. The trigger can unlock the guard without moving the guard. When the guard moves between an extended position in which the blade is completely covered, a portion of the blade extends from the guard into an operating position.

Preferably, when the knife is in a locked position, the guard returns to an extended position, which can automatically re-locks the guard. The trigger that cooperates with the locking mechanism can unlock the guard. When the guard is unlocked, the guard returns to the extended position automatically and re-locks itself, even if the trigger is concurrently positioned to unlock the guard. Then when the guard is automatically re-locked, the guard can only be unlocked after releasing the trigger back to its normal position. Preferred locking mechanism utilizes a pawl that is spring biased towards a locked position.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective side view of the utility knife.

FIG. 2 is an exploded view of the utility knife.

FIG. 3 is a side view of the utility knife in FIG. 1 showing the trigger in an unpressed state.

FIG. 4 is a side view of the utility knife in FIG. 1 showing the blade guard in a retracted position, with the blade exposed.

### DETAILED DESCRIPTION

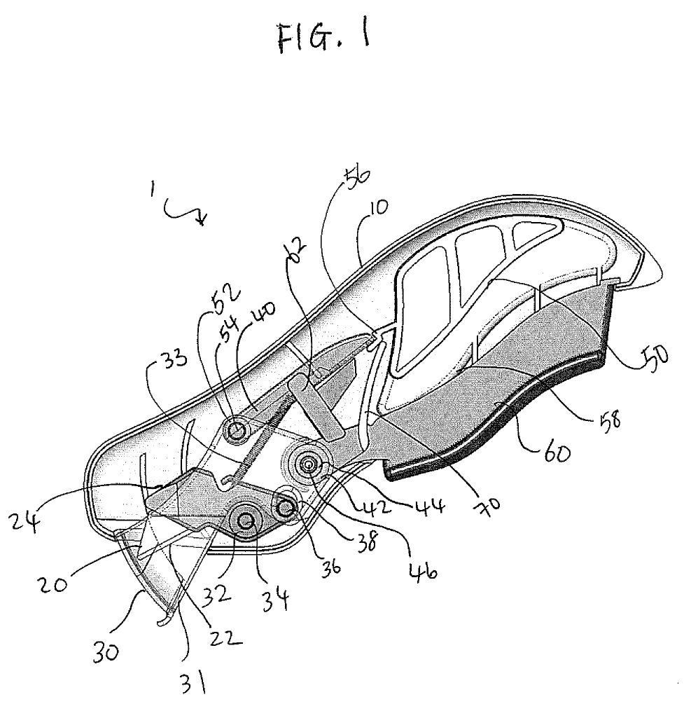

In FIG. 1 a utility knife 1 generally comprises a housing 10 (only the front portion of which is shown), a blade 20, a blade guard 30, a pawl 40, and a trigger 60.

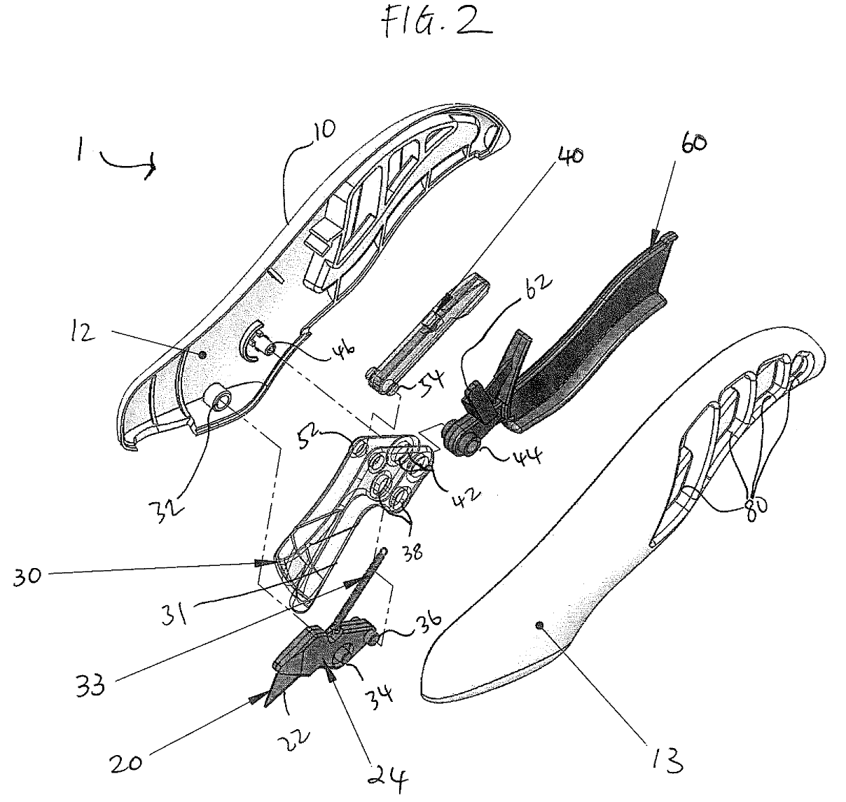

Housing 10 is preferably sized and dimensioned to fit comfortably in the hand of a user. Housing 10 can be made of any suitable material, including metals, alloys, and plastics, and can have a hollowed out section (not shown) for storing spare blades. Housing 10 is preferably ambidextrous, but alternatively can include contours that would tend to make the device more acceptable to right or left handed use. Housing 10 pivots about first pivot 32 which allows for housing 10 to be connected to first pin 32 of blade holder 24. Preferably, grooves 80 are located on the outside of housing 10 (as shown in FIG. 2) for better comfort and gripping. Grooves 80 are slots that can either be open or closed, depending on the user's preference.

Blade 20 is preferably triangular shaped at one or both ends, and has at least one cutting edge 22. Blade 20 is preferably made of non-rusting alloy, but can also be made of other materials, including for example various plastics. Blade 20 is shown here as being held by blade holder 24.

Blade guard 30 generally guards the blade 20 when the guard is in a fully deployed position (see FIG. 4), and allows use of the blade when the guard is in the retracted position (see FIG. 1). It is preferred that the blade mechanism is held together with four pivots which connects the blade guard, the blade holder, the trigger and the pawl. However, it is contemplated that there can be fewer or more pivots that hold together the parts to form the present blade mechanism.

To that end blade guard 30 has a slit along one edge 31 through which at least a portion of the edge 22 of blade 20 can extend. Blade guard 30 is continuous with spring 33 and pivots preferably at three different pivot points. Second pivot 38 is disposed at the near rear portion of blade guard 30 and connects to second pin 36 of blade holder. Third pivot 42 is located at the furthest corner of blade guard and connects to a third pin 44 of trigger 60 and also to a third small pin 46 of pawl 40. Finally, fourth pivot 52 is located at the topmost corner of blade guard 30 and is connected to fourth pin 46 on housing 10. It is contemplated that a multiple arrangements of pivot and pins are possible. Blade guard 30 is preferably made of transparent or at least translucent plastic, so that the user can see the blade being protected. Alternatively, blade guard 30 can be made of metal or any other suitable material or materials.

Pawl 40 extends from carriage 50 by pushing against catch 56 of carriage 50 and pivots to blade guard 30 via fourth pin 54 through fourth pivot 52 of blade guard. Pawl 40 also cooperates with carriage stop 52 to prevent carriage from pivoting and thereby prevents the blade guard 30 from retracting. Spring 33 of blade holder 24 is also attached to pawl 40 and allows pawl 40 to have some degree of springiness. Pawl 40 also is attached to connector 62 which connects pawl 40 to trigger 60. Pawl 40 is preferably constructed of a single, continuous piece of metal alloy, or plastic.

Carriage 50 extends from the rear portion of housing 10 and is part of housing's mold. Preferably carriage 50 has a carriage stop 58 that prevents pawl 40 for a complete release of trigger 60. Striking rest 70 is placed in between carriage stop 58 and trigger 60. Carriage 50, stop 58, and striking rest 70 can be made from any suitable material or materials, and can be shaped as shown or can have any other suitable shapes.

Trigger 60 is shown on the underside of the housing 10, and is positioned relatively forward so that the trigger is easily operated by the users forefinger. All other suitable positions are contemplated, including positions on the top or side of the housing 10. Those skilled in the art will also appreciate that the trigger 60 is merely emblematic of a more general actuator, which could take the form of a button, a push button, a slider, or even multiple actuator mechanisms and so forth. Trigger 60 is preferably constructed from metal or plastic.

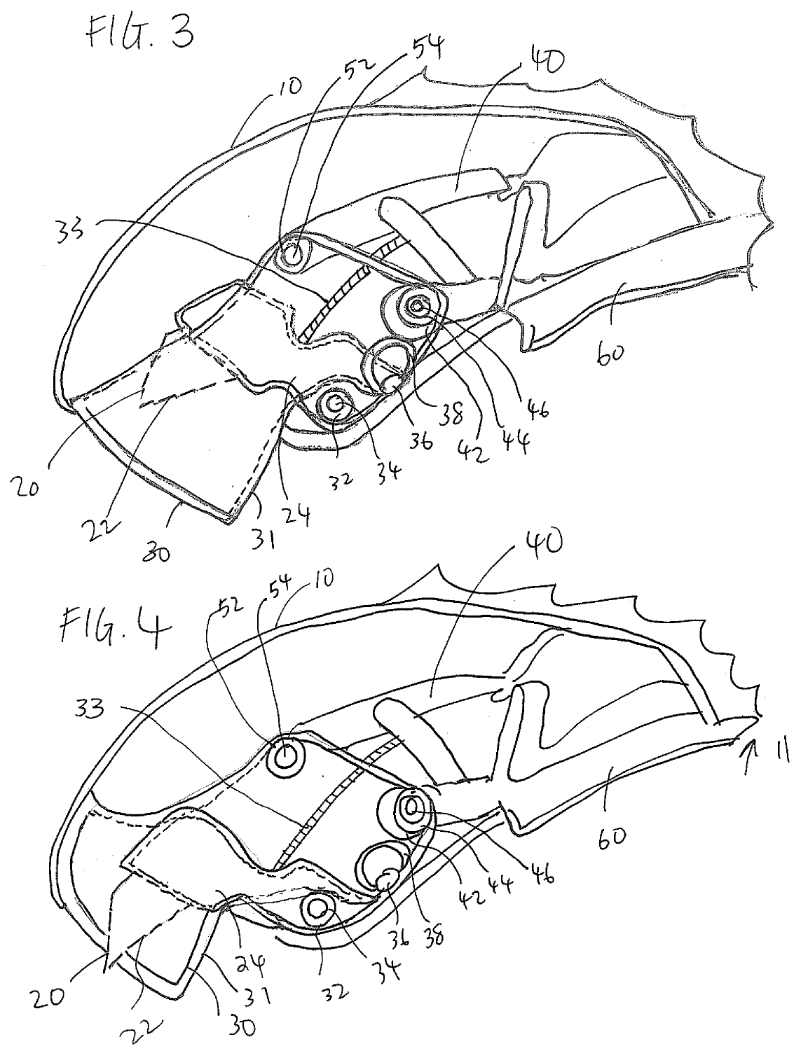

In FIGS. 1 and 3, the utility knife 1 is shown with the blade guard 30 in the deployed (protecting) position, and blade 20 is in retraced position inside blade guard 30. Preferably, blade 20 is completely locked inside housing 10. Locking is accomplished by the approximate juxtaposition of striking rest 70 against catch 56 and against pawl 40. In this position the maximum distance between striking rest 70 and catch 56 determines the play (slight movement) that blade guard 30 can undergo. As such it is beneficial if the distance 55 is less than 5 mm, more preferably less than 3 mm, even more preferably less than 2 mm, and most preferably less than 1 mm.

Pawl 40 also attaches to blade 24 holder via spring 33 (also shown in FIG. 2) and this allows blade 20 to be in a retracted state while the trigger is not being depressed. Pawl 40 also connects via fourth pivot 52 to fourth pin 54 between housing 10 and glade guard 30 to stabilize blade guard 30 into a protected position, i.e., extending from the housing and retracting blade 20. This is further advanced by the pivoting mechanism of third pivot 42 against third small pin 46 and third pain 44 of trigger 60. So when trigger 60 is not depressed, third pivot 42 is stationary and holds blade guard in place and prevents the blade from extending outside of the housing. So blade guard 30 is in a locked state and is completely covering blade 20 and extends all the way out of housing 10 so there is no access to the blade thus making it safe for handling. Trigger 60 pivots about third pivot with third pin 44 and is fully extended out of housing 10 and in the ready position to be squeezed, pushed or activated.

In FIG. 4, trigger 60 has been depressed (squeezed) against the housing 10 in the direction of arrow 11, the blade is still in the housing and has not moved or extended outside the housing from its locked state. However, as trigger 60 is further depressed into the housing, blade guard is now in an unlocked state and is free to be pushed into the housing. This leads to the operation of the counter-reciprocating action between blade and blade guard. As blade guard 30 becomes unlocked, it is further pressed into housing 10, blade 20 extends from housing 10 equal distance and can be used to cut into a surface as it is pressed against. Once the user finished a cut, the user preferably can lift the knife off the surface which will allow the knife to go back into its relaxed and locked state whether the trigger is still depressed or not. To reset the knife, the user simply release the trigger and returns to its original state.

The pivoting mechanisms allows for counter-reciprocating motion of the blade guard and the blade. As user is depressing trigger 60, third pivot 42 moves in one direction which causes second pivot 38 to move in the opposite direction. Setting off a chain event, second pivot 38 moves first pivot 32 in the opposite direction. This series of pivoting motion moves blade guard 30 further into housing 10 in an automatically unlocked position and pushes blade holder 24 extending down from the housing. As the trigger is depressed to its maximum state, the blade extends out from the blade guard and the blade guard retracts. Having spring 33 on blade holder 24 allows pawl 40 to maintain a spring biased to a locked state. This ensures that blade 20 will not entirely be out of the housing.

As the user is cutting, return of the blade guard to the extended position automatically re-locks the guard, even if the trigger is concurrently positioned to unlock the guard. Once after the guard is automatically re-locked, the guard can only be unlocked after releasing the trigger to a default position.

The advantage of the current knife is enormous. Since the blade will not come out of the housing unless the guard is locked and the guard is actually pressed against a surface, activation of the blade guard is the only way the knife will cut. Thus, if the blade guard is tampered with in a way, such as being broken off, the blade will not come out of the housing and thus cannot cause accident injuries. Since the blade is always behind the blade guard or in the housing, this provides maximum safety and double protection against a user from being cut.

Thus, several specific embodiments and applications of utility knives have been described. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A utility knife having a counter-reciprocating blade and guard.

2. The utility knife of claim 1, further comprising a housing, a first pivot that pivotally couples the housing and the blade, and a second pivot that pivotally couples the housing and the guard.

3. The utility knife of claim 1, further comprising a coupling mechanism that couples reciprocation of the blade and guard such that forced retraction of the guard results in forced extension of the blade.

4. The utility knife of claim 3, wherein the blade is disposed within a blade holder, the blade holder pivots about a first pivot, and the guard is pivotally coupled to the blade holder at a second pivot positioned eccentrically to the first pivot.

5. The utility knife of claim 1, further comprising a housing, and a locking mechanism that locks the guard in a locked position.

6. The utility knife of claim 5, wherein the locking mechanism is entirely internal to the housing.

7. The utility knife of claim 5, wherein the blade extends from a edge of the housing when the guard is in the locked position.

8. The utility knife of claim 5, wherein the blade is entirely disposed within the housing when the guard is in the locked position.

9. The utility knife of claim 5, further comprising a trigger that cooperates with the locking mechanism to unlock the guard.

10. The utility knife of claim 9, wherein the trigger extends inferiorly from a lower surface of the housing.

11. The utility knife of claim 9, wherein movement of the trigger unlocks the guard without moving the guard.

12. The utility knife of claim 5, wherein the guard moves between an extended position in which the blade is completely covered, and an operating position in which at least a portion of the blade extends from the guard.

13. The utility knife of claim 12, wherein the locking mechanism operates such that return of the guard to the extended position automatically re-locks the guard.

14. The utility knife of claim 12, further comprising a trigger that cooperates with the locking mechanism to unlock the guard, and wherein the locking mechanism operates such that return of the guard to the extended position automatically re-locks the guard, even if the trigger is concurrently positioned to unlock the guard.

15. The utility knife of claim 14, wherein the locking mechanism operates such that after the guard is automatically re-locked, the guard can only be unlocked after releasing the trigger to a default position.

16. The utility knife of claim 5, wherein the locking mechanism comprises a pawl that is spring biased towards a locked position.
